(19) United States
(12) Patent Application Publication
(10) Pub. No.: US 2010/0263595 A1
(43) Pub. Date: Oct. 21, 2010

(54) METHOD FOR THE COMPUTER-BASED IDENTIFICATION OF MASTITIS

(75) Inventor: Heinz Francke, Oelde (DE)

Correspondence Address: SEED INTELLECTUAL PROPERTY LAW GROUP PLLC, 701 FIFTH AVE, SUITE 5400, SEATTLE, WA, 98104, US

(73) Assignee: Westfaliasurge GmbH, Bonen (DE)

(21) Appl. No.: 11/917,145

(22) PCT Filed: Jun. 8, 2006
(86) PCT No.: PCT/EP06/05500

§ 371 Date: Jun. 28, 2010

(30) Foreign Application Priority Data
Jun. 9, 2005 (DE) 10 2005 026 723.8

(51) Int. Cl. A01J 5/013

(52) U.S. Cl. 119/14.08

(57) ABSTRACT

A method for the computer-based identification of mastitis of milk-producing animals of a herd, wherein individual animals are automatically identified by an animal identification means of a herd management system, and a milk sample assigned to the animal is taken and analyzed for the identification of mastitis. The method takes into account the fact that different animals in a herd have an individual tendency to contract mastitis, so that not all the animals in said herd have to be examined with the same frequency for a possible case of mastitis, and the method according to the invention correspondingly proposes that after the animal identification process, the herd management system decides whether a milk sample is taken and/or analyzed, based on animal-specific information that is stored in the herd management system.

### BACKGROUND

1. Technical Field

The present invention relates to a method for the computer-based identification of mastitis in the milk-producing animals of a herd according to the features of the preamble of claim 1.

2. Description of the Related Art

In intensive dairy farming, nowadays milk-producing animals, for example cows, are always kept in a herd. Each individual animal carries a signal transmitter, for example a transponder, by which it is possible to read out the identity of the animal in the proximity of a read-out apparatus. Such read-out apparatuses are normally provided at a milking place, so that during milking, not only the performance of the animal to be milked with respect to the milk production can be animal-specifically observed and analyzed, but that there is moreover a possibility of animal-specifically administering food, dietary supplements and/or drugs base on the animal identification. The signals of the animal identification means are entered into a herd management system which can animal-specifically store and analyze the essential features of performance of the milk-producing animals, and in which furthermore animal-specific information, such as the behavior of the animals during milking, which have an influence on the automatic or semi-automatic control of plant parts at the milking parlor, as well as the amount and composition of the food amount to be dispensed at the milking parlor is stored.

Moreover, during the stay of the animal at a milking place, there is the possibility of taking a milk sample from the taken milk which can be assigned to the corresponding animal based on the animal identification means and is then subjected to an analysis. In this analysis, various parameters of milk quality can be examined. In particular, however, one usually examines whether the corresponding animal has contracted mastitis.

Methods and devices for examining the milk of milk-producing animals of a herd are well-known, for example, from WO-03/048771 and WO-02/069697. With the device according to WO-02/069697, with each milking of an animal of the herd, a milk sample is to be taken and analyzed for contained substances indicating a case of mastitis. With a relatively large amount of apparatuses and also personnel, each individual animal has to be completely observed, so that diseases can be directly identified and appropriate measures, such as a treatment with medicine and in particular disinfection for avoiding a spread of the disease within the herd, can be taken.

However, it showed in practice that all automatic methods for the identification of mastitis during milking have a poor rate of identification of 20 to 50% with an error rate of more than 85%. These methods in particular include observing the conductivity of the milk flow or the temperature thereof, or observing the change of the overall milk amount of an animal to be milked. Other methods where a sample is taken from the milk flow and analyzed on location have a slightly better rate of identification of 50 to 80%, the error being approximately 50 to 70%. Though with this method mastitis can be identified with higher probability, these methods still involve errors. Moreover, the sample treatment requires personnel.

There are methods where a separate apparatus is installed in the milking unit and measures certain physical properties of a sample of taken milk, for example conductivity or temperature. Alternatively, a sample can also be examined manually, for example with an indicator paper, which, however, requires considerable practice in the use of such analysis methods, so that time consuming training is necessary and faulty manipulations can not be excluded. Recently, DeLavall DCC introduced an analysis kit for carrying out chemical analyses which was said to diagnose a case of mastitis of an animal with relatively high accuracy. The use of the test kit, however, requires a special, relatively expensive test apparatus. The chemical analysis substances employed in the method are consumables and have to be constantly replaced. The laboratory character of the analysis method moreover renders the performance thereof time consuming. Nothing is known yet about the accuracy and reliability of this new method. The previously known method is said to be performable by a person operating the milking plant, so that the measuring results are present directly on location which is an advantage over analyses of a milk sample by veterinaries or external test laboratories where the feedback of the test results is extremely slow. Nevertheless, there is the principle that with an increased accuracy and reliability of the method, an increasing amount of technical laboratory equipment and time are required for obtaining the necessary measuring results.

Accordingly, at present no reliable and cost-effective methods for the identification of mastitis with individual animals of a herd are known. Examination methods where the flow of taken milk is analyzed are inaccurate. The laboratory analysis of milk samples is complex and can, under economic points of view, not be used for a consistent or frequent analysis of the milk taken in the milking procedure.

### BRIEF SUMMARY

It is an object of the present invention to provide a method for the computer-based identification of mastitis of milk-producing animals overcoming the above problems at least partially.

For achieving this object, the present invention provides a method with the features of claim 1. It differs from generic methods in that after the animal identification and based on animal-specific information stored in the herd management system, the herd management system decides whether a milk sample is taken and/or analyzed. In the method according to the invention, a decision of whether a sample is taken and/or analyzed of a certain animal which is in each case just standing at the milking parlor is accordingly made based on animal-specific information stored in the herd management system. For the analysis, in particular the automatic analysis, of the milk sample, each known method can be employed, for example those where the physical properties, the conductivity or temperature of the milk flow are analyzed, and which can be correspondingly carried out relatively inexpensively, as well as complex enzymatic or wet-chemical methods.

As a departure from the known solution suggestions, however, the sample is not taken and analyzed of each animal during each milking operation, nor is a sample taken and analyzed of each animal at predetermined intervals. A decision of whether in the predetermined milking operation of a certain animal a milk sample is taken and analyzed or the milk flow is analyzed without taking samples is rather made based on the animal-specific information. The animal-specific information in particular includes the medical records of the corresponding animal to be milked, in particular the tendency of the animal to contract mastitis which is stored in the herd management system.

Moreover, in the herd management system, parameters should be preferably stored which are obtained from measurements or from historic values, and which do not necessarily permit a conclusion to the presence of a case of mastitis, but at least show signs of a beginning case of mastitis. As parameters, preferably such values are used which can be easily obtained, preferably directly from the flow of the obtained milk, without many and/or complex apparatuses, here the lactate contents of the obtained milk, the so-called lactate state is mentioned.

In the method according to the invention, accordingly the herd management system present in modern milking devices anyway is used for making a decision for each animal individually whether a sample of the corresponding identified animal is taken which usually is in the milking parlor at this point in time. In the herd management system, animal-specific information is always stored and supplemented or overwritten when the milk is taken. These include in particular the amount of the taken milk. Furthermore, the milking duration can be determined, and thus, the amount of milk obtained per time unit can also be output by means of the herd management system. These measured values already can be utilized as parameters for a beginning mastitis.

According to a preferred further development of the present invention, mastitis risk classes are stored in the herd management system. For each of these mastitis risk classes, analysis intervals are stored which state the frequency at which the animals classified in the corresponding mastitis risk class are examined with respect to a possible mastitis disease. The result of the corresponding mastitis examination can be entered into the herd management system according to a further preferred embodiment of the present invention, and the classification of the individual animals in the mastitis risk classes can be changed based on the entered results. The above-mentioned parameters which do not yet permit a definite statement of whether an animal has contracted mastitis but indicate a beginning case of mastitis, can be utilized according to a further preferred embodiment of the present invention to classify the corresponding animal in a higher mastitis risk class. The highest mastitis risk class is the class, in which these animals of a herd are classified which contract mastitis most often. In the lowest mastitis risk class, those animals are classified which, for example, have never contracted mastitis. If the animals remain inconspicuous over a predetermined period, i.e. neither a case of mastitis nor hypercritic parameters are identified, the animals are classified down in a lower mastitis risk class.

To avoid a contamination of the animals of a herd by an animal newly admitted to the herd, this newly admitted animal is classified in the highest mastitis class according to a further preferred embodiment of the present invention. This classification is preferably effected automatically when the animal newly admitted to the herd is first identified for taking a sample. The point in time is usually equal to the first appearance of the animals newly admitted in the herd at the milking place for taking milk. Up to this point in time, the identification of the animal stored in the herd management system can be provided with a marker which is overwritten at the first appearance of the animal at the milking parlor.

With the method according to the invention, a possibility of avoiding unnecessary analysis methods and examinations of animals which only have a low or no tendency to contract mastitis is provided. All information indicating such tendencies or showing signs of these tendencies can be entered into the herd management system beforehand or are preferably automatically written into the same by permanent analysis during the taking of milk. Only those animals of a herd are analyzed for a case of mastitis with high frequency which have a corresponding disposition. Unnecessary analyses are thus avoided which saves costs and working time without having to dispense with a comprehensive, preferably consistent observation of endangered animals. These advantages are already achieved by the application of a very accurate, for example an enzymatic or wet-chemical method for the examination of mastitis for each individual taken sample. In a further development of the method, a certain analysis method is assigned to each predetermined mastitis risk class. Different methods are assigned to different mastitis risk classes, and the analysis of the milk sample of the animal assigned to the corresponding mastitis risk class is preferably effected automatically with the analysis method assigned to the mastitis risk class. The selection of the methods is preferably also effected automatically. For analyzing animals of a medium mastitis risk class, preferably a relatively simple and inexpensive method, for example a physical measuring method, is employed, which involves errors, but which leads to reliable results due to the frequency of the taking of samples. With critical animals, preferably an analysis method with a low error rate is assigned to the mastitis risk class, so that a case of mastitis of such an animal is directly and reliably identified.

All above-mentioned procedure steps are preferably carried out in an automated manner and controlled by the herd management. This also includes the control of the analysis device(s) for carrying out the analysis, including an animal-specific taking of samples, analysis and assignment of the measured results to the certain animal.

### DETAILED DESCRIPTION

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for the computer-based identification of mastitis of milk-producing animals of a herd, wherein individual animals are automatically identified by an animal identification means of a herd management system, and a milk sample is taken from the animal and analyzed for the identification of mastitis and wherein, after the animal identification, the herd management system decides whether a milk sample is taken and/or analyzed, based on animal-specific information stored in the herd management system, the method comprising,
storing mastitis risk classes and analysis intervals assigned to the mastitis risk classes in the herd management system, and examining the identified animal for mastitis based on its affiliation to a mastitis risk class after the lapse of an interval for this class.

2. The method according to claim 1, comprising entering a result of the mastitis examination into the herd management system, and effectuating the classification of individual animals in the mastitis risk classes based on the entered results.

3. The method according to claim 2, wherein the assignment to a mastitis risk class is effected based on parameters that show signs of a beginning case of mastitis.

4. The method according to claim 1, comprising storing different analysis methods for individual mastitis risk classes in the herd management system, and examining the milk sample of an animal assigned to a certain mastitis risk class for mastitis with an analysis method assigned to the class.

5. The method according to claim 4, wherein for the examination of animals with a high mastitis risk class, an analysis method with a low error rate is employed, and for the examination of animals with a lower mastitis risk class, an analysis method with a higher error rate is employed.

6. The method according to claim 1, wherein an animal newly admitted to the herd is classified in the highest mastitis risk class.

7. The method according to claim 6, wherein the animal newly admitted to the herd is classified in the highest mastitis risk class when it is identified for the first time for taking a sample.

8. The method according to claim 2, wherein different analysis methods are stored for individual mastitis risk classes in the herd management system, and that the milk sample of an animal assigned to a certain mastitis risk class is examined for mastitis with the analysis method assigned to the class.

9. The method according to claim 8, wherein for the examination of animals with a high mastitis risk class, an analysis method with a low error rate is employed and for the examination of animals with a lower mastitis risk class, an analysis method with a higher error rate is employed.

10. The method according to claim 8, wherein an animal newly admitted to the herd is classified in the highest mastitis risk class.

11. The method according to claim 10, wherein the animal newly admitted to the herd is classified in the highest mastitis risk class when it is identified for the first time for taking a sample.
